(19) United States
(12) Patent Application Publication
(10) Pub. No.: US 2012/0211682 A1
(43) Pub. Date: Aug. 23, 2012

(54) Propane tank lock

(76) Inventors: Ming Liang Shiao, (US); Franklin D. Minnella, (US)

(21) Appl. No.: 12/932,215

(22) Filed: Feb. 22, 2011

(51) Int. Cl. F16K 35/00

(52) U.S. Cl. 251/93

(57) ABSTRACT

A configurable valve lock consists of two main components, a valve lock cover and a valve lock cap. The valve lock cover is a hollow cylinder with a top, an open bottom and a side. The top has an opening that accepts a portion of the valve lock cap. The interior surface of the cover may be threaded to join with the threaded propane tank valve or may be configured to fit multiple types of connections. The exterior surface of the cover may be faceted to accept a tool, such as a wrench, to firmly tighten the cover onto the propane tank valve.

The valve lock cap is a hollow cylinder with a top, side and an open bottom. The top holds a cap lock. The cap lock has a stem that extends into the interior of the cap. The stem has a latch that extends outwardly into the interior of the cap/cover or retracts into the stem. The interior circumference of the cap is slightly larger than the exterior circumference of the cover and when installed, the cap freely rotates around the cover.

After connecting the cover onto the propane tank valve, the cap fits over the cover by inserting the stem into the opening of the cover top and sliding the cap onto and over the cover. The cap is locked into place by extending the latch of the cap lock to prevent the vertical movement of the cap from the cover.

### FIELD OF THE INVENTION

The present invention relates generally to the field of locks and more specifically, to a lock for a standard propane tank control valve. One such control valve is the fill valve, used to fill a propane tank. Because, the unauthorized access to propane tank valves could have disastrous effects, a lock on these valves prevents tampering, loss of contents or damage to the tank and/or to its contents.

### BACKGROUND OF THE INVENTION

Liquid propane gas is an energy source and supply for residential, agricultural, industrial and commercial applications all around the world and is normally stored in metal tanks. Since the uses of propane vary, a propane tank is manufactured in several different sizes, ranging from the compact gas grill tank to large underground storage facilities. All propane tanks are designed to withstand pressure, airtight, and have at least one valve. Many propane tanks have several valves and gauges. In a multi-valve tank, the main valves are the fill valve to deliver gas to the tank, the service valve to release the propane to downstream appliances and a relief valve to vent excessive pressure. Tanks may also have a float gauge to measure the level of liquid in the tanks and a vapor recovery valve to release excess vapor in the tanks during service.

Typically, a propane tank is filled via the fill valve. A propane supply system is attached to the propane tank fill valve. Liquid propane is then forced into the tank under pressure and stays pressurized inside the tank until a service valve slowly releases the contents. When the service valve is opened the gas turns to vapor and escapes through the service valve opening into lines that feed downstream appliances connected to the tank. Because propane gas is highly flammable, tampering or modifying the propane tank, its valves, or connections can be explosively dangerous. It is therefore appropriate to develop methods to secure various propane tank valves and other parts.

The present invention relates to a way to secure the propane tank fill valve. When propane is delivered to a local storage propane tank, the tank is connected to the propane delivery container by connecting a hose from the delivery device to the propane tank fill valve. Typically, the hose end coupling of the delivery device is screwed onto the filler valve and seated firmly against a gasket to prevent gas from escaping during delivery. After the hose is connected to the propane tank, the filler valve and hose-end valve are opened and propane begins to flow into the tank. A comprehensive discussion of propane tank fill valve technology is found in U.S. Pat. No. 6,367,775 issued on Apr. 9, 2002 to Nimberger, for a “Universal Fill Valve”. The protection of the fill valve is important as it operates as the first line of supply in the gas supply system.

A significant problem with propane tanks is that there has not been a simple and economical way to secure the fill valve. Thus, the fill valve is susceptible to damage from vandalism or other problems. Further, many people rent their propane tanks. If the renter fails to pay the rent for the tank, there was no way for the rental company to secure payment, absent physically removing the tank. This requires access to the land, which is not given by the non-paying renter. The non-paying renter is therefore free to re-fill the tank from another supplier. Thus, there is a need to properly secure the fill valve to prevent unauthorized access to the tank or vandalism to the valve. In the past, some propane tank valves have been secured by means of large metal covers that are cumbersome and expensive. Other tanks have been surrounded by a fence, which is still cumbersome and expensive. The multiple disadvantages of prior art are overcome by the present invention, which provides a compact, inexpensive and secure method of preventing access to the fill valve. Such a propane tank fill valve lock is therefore disclosed herein.

### SUMMARY OF THE INVENTION

The lock of the present invention may be used to reliably control access to the fill valve by means of a propane tank valve lock. The lock is simple to use, inexpensive and tamper-resistant. Because prior art failed to deliver an easy and economical way secure the fill valve, the present invention has been very well received in the industry. The viable economic reception in the marketplace has evidenced the long felt need for such a device.

The valve lock of the present invention has two major components: a valve lock cover and a valve lock cap. The valve lock cover fits over and screws onto the propane tank fill valve. The cover is hollow and cylindrical in shape and has a top, an interior and exterior surface and an open bottom. The top of the cover has an opening that receives a stem in the valve lock cap's plug cylinder lock (described in detail below). The cover's interior is threaded to allow it to screw onto an exterior-threaded standard propane tank valve. The exterior surface of the sidewall of the cover is faceted to allow an installer to tighten the cover securely onto the valve with a tool, such as a standard adjustable wrench. The cover is affixed to the fill valve by placing its open bottom over the fill valve, screwing the cover onto the fill valve and tightening as necessary. After the cover is affixed to the fill valve, the locking valve lock cap (described immediately below) is affixed to the valve lock cover.

The locking valve lock cap is also cylindrical in shape, hollow and open at the bottom, generally conforming to the shape of the valve lock cover. When installed, the locking valve lock cap fits over the valve lock cover: A plug cylinder lock is encased within the cap. The plug cylinder lock includes a stem that, when the cap is installed, extends through the opening in the top surface of the valve lock cover and into the interior of the cover. The lock also includes a latch that extends radially outwardly from the stem into a locked position. In this position, the protruding latch, now located in the interior of the valve cover, extends beyond the lip of the valve cover opening. With the cap locked into place over the cover, the interaction between the extended latch and the valve cover prevents the cap from being removed until the plug cylinder lock is unlocked. Additionally, the cap freely rotates around the underlying cover to prevent access by twisting off and thereby breaking the cap and/or cover. Further, the cap and cover are securely affixed to the fill valve so that the cap and cover cannot be pried off without also breaking the propane tank fill valve.

It is therefore an object of the present invention to provide a propane tank fill valve lock which economically, quickly and easily secures the propane tank fill valve in a way which is not anticipated, rendered obvious, suggested, or even implied by any of the prior art, either alone or in any combination thereof.

It is another object of the present invention to provide a propane tank fill valve lock which is of a durable and reliable construction.

An even further object of the present invention is to provide a propane tank fill valve lock of simple design which is susceptible of a low cost of manufacture with regard to both materials and labor, and which accordingly is then susceptible of low prices of sale to the consuming public, thereby making such apparatus economically available to the buying public.

An even further object of the present invention is to provide a propane tank fill valve lock that is much more compact than any prior art, rendering it easy to transport and use.

These together with other objects or the invention, along with the various features of novelty that characterize the invention, are pointed out with particularity in the claims that form a part of this disclosure. For a better understanding of the invention, it's operating advantages and the specific objects attained by its uses, reference are made to the accompanying drawings and descriptive matter in which there are illustrated preferred embodiments of the invention.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

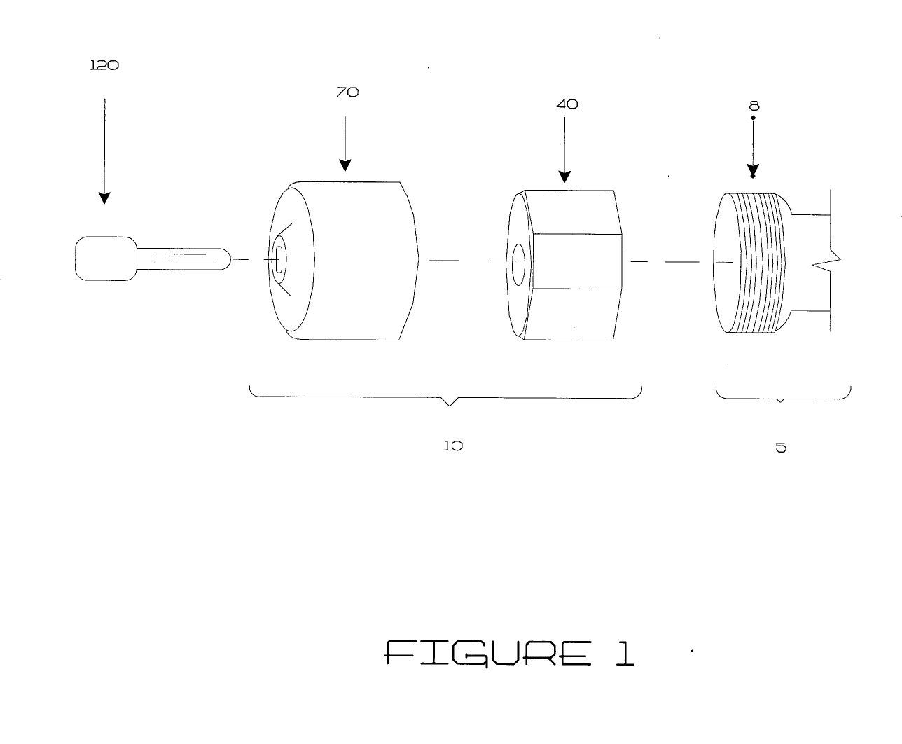

1. FIG. 1 is a simplified view of the valve cap and cover of the invention as they are horizontally aligned to affix onto a propane tank valve posed horizontally. The propane tank itself is not shown.

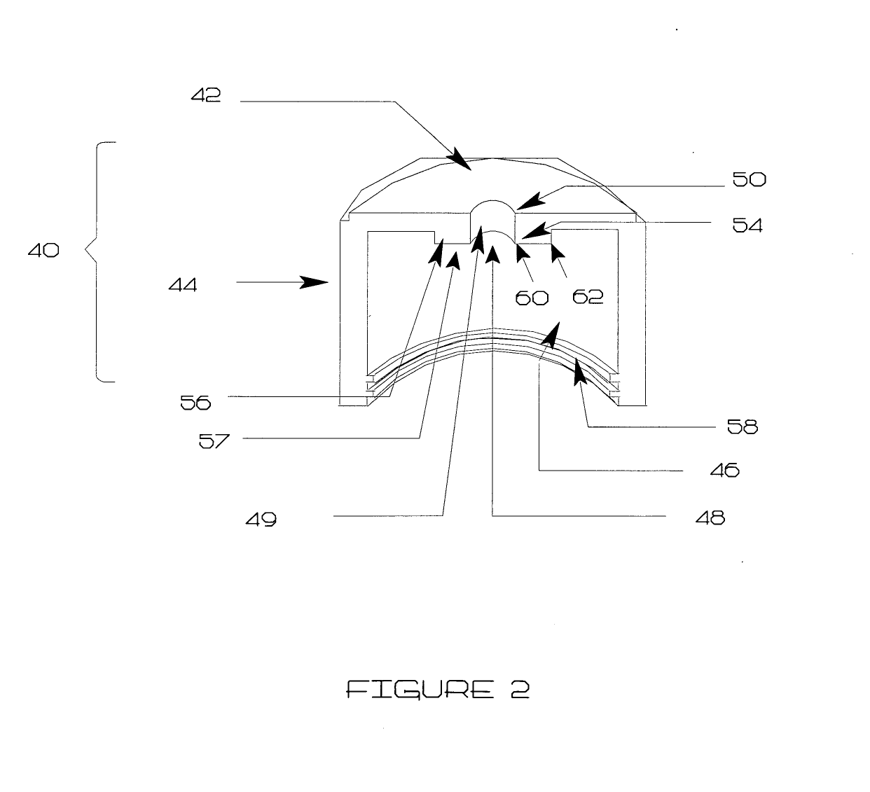

2. FIG. 2 is a simplified cross-sectional view of the valve lock cover posed vertically;

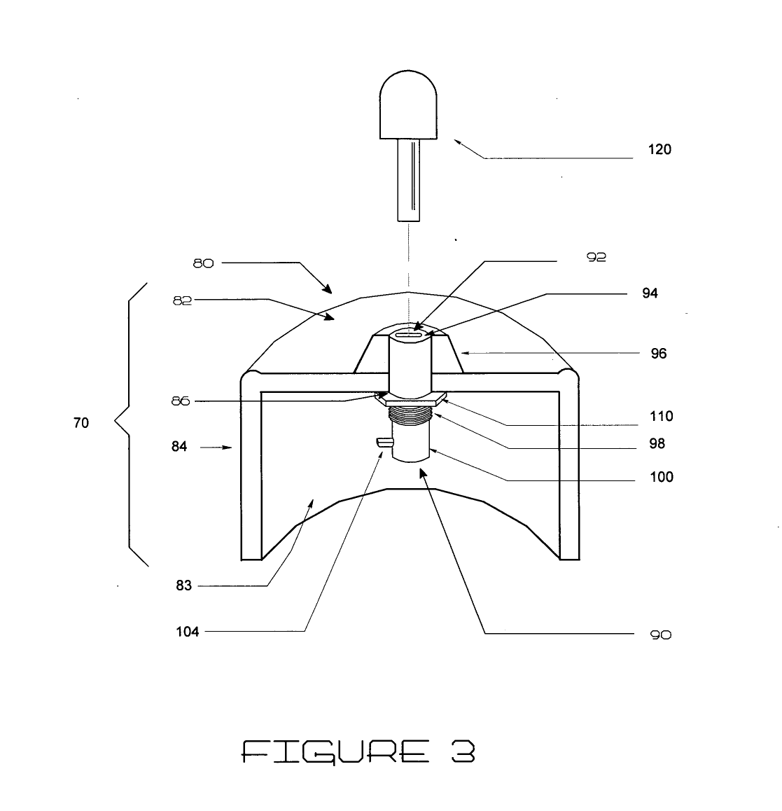

3. FIG. 3 is a simplified cross-sectional view of the valve lock cap posed vertically.

### DETAILED DESCRIPTION OF THE PREFERRED EMBODIMENT

The present invention is suitable for use in securing a propane tank valve and thereby preventing misuse, vandalism or theft. Propane tanks of various sizes are widely used in many countries for residential, commercial and industrial applications. Of course, the tank's contents should always be secured to protect from vandalism or unauthorized access. To date, there has been no simple and efficient way to do this, without securing the entire tank. The present invention provides a simpler, more economical and efficient way to secure the tank by blocking access to the tank's valves. In the following explanatory description, specific component arrangements and constructions and other details are set forth in order to provide a more thorough understanding of the present invention. It will be apparent to those skilled in the art, that the present invention may be practiced without the specific details enumerated herein. Some well known manufacturing methods and structures have not been described in detail so as to refrain from obscuring the present invention unnecessarily.

As shown in FIG. 1, the present invention is a propane tank valve lock 10 comprises a key 120 that fits into a valve lock cover 40 which covers a valve lock cap 70 which fits onto a propane tank filler valve 5. A standard propane tank filler valve 5 has a high filling capacity, one-piece body and is used primarily for filling ASME containers or portable DOT cylinders. The filler valve 5 is normally equipped with 1¾″ Acme filling connection and ¾″ NPT container thread 8. As explained in detail below, the propane tank valve lock 10, securely locks onto the propane tank filler valve 5, thereby blocking access to the valve 5. Design features incorporated into the propane tank valve lock 10 prevent it from being dislodged by drilling, prying, torque or any other non-fatally disruptive technique currently known in the industry.

The valve lock 10 is comprised of two major sub-components, a valve lock cover 40 and a valve lock cap 70. The valve lock cover 40 is designed to screw directly onto the filler valve 5. The valve lock cap 70 is designed to fit onto the valve lock cover 40. In the preferred embodiment, both generally conform in shape to the exterior surface of the fill valve 5. After the valve lock 10 is affixed onto the fill valve 5, a key 120 locks the propane tank fill valve lock 10 into place. The valve lock cover 40 sub-component is the first sub-component to be affixed to the filler valve 5 and is discussed in detail immediately below. A discussion of the cap 70 follows immediately thereafter. After that, the assembly of the sub-components and the placement of the fill valve lock 10 onto the filler valve 5 are presented.

To install a fill valve lock, the valve lock cover 40 sub-component is first affixed onto the fill valve 5. Referring next to FIG. 2, the valve lock cover 40 sub-component is shaped to screw onto the fill valve 5. The valve lock cover 40 is made of rust-resistant brass, essentially cylindrical in shape and hollow, has a top surface 42, an exterior sidewall 44, an interior sidewall 56 and an open bottom. The cover's top surface 42 includes an aperture 48 that is large enough to accept the stem of a plug cylinder lock (described below and illustrated in FIG. 3). The top surface aperture 48 has a sidewall 49 extending axially longitudinally into the interior of the valve lock cover 40. The sidewall 49 has a proximal end 50 integrated into the valve cover top surface 42 and a distal end 54 located within the interior space of the valve lock cover 40. The distal end 54 has a lip 56 radiating longitudinally away from the aperture 48, creating a flat, smooth lip surface 57. The sidewall distal end 54 combines with the lip 56 to form a first edge 60 opening to the aperture 48. The lip 56 has a second edge 62 distal to the aperture 48.

The cover's exterior sidewall 44 is faceted to allow a tool, such as a wrench, to more securely grip it. The exterior sidewall 44 is at least as long as the length of the filler valve 5. The cover's interior surface 46 is at least partially threaded 58 to match the propane tank filler valve exterior surface threading 8 (shown in FIG. 1). Using these design features, the cover 40 is threaded and then tightened into place over the fill valve 5. After the cover 40 is seated onto the fill valve 5, the fill valve lock's 10 second major sub-component, the lock valve lock system 70, is installed.

While the valve lock cover 40 sub-component of the present invention is designed to connect to a standard fill valve 5 having an exterior threaded surface, the valve lock cover 40 may also be designed in alternative embodiments to fit other types of valves. Because the valve lock cover 40 sub-component is separate from the valve lock cap 70 sub-component, the interior of the valve lock cover 40 can be configured to house a snap-on connection, a quick-connect connection, a quarter-turn connection or any other type of connection used in the industry. Such connections are well-known throughout the industry and a discussion of quick connect connection devices is found in U.S. Pat. No. 5,386,850 issued to Emery. In addition to being configurable to a variety of connections, the valve lock cover 40 can be configured to different sizes of valves. In these alternative embodiments, the valve lock cover 40 becomes the housing for the type of connector needed. The requisite connector fits within the valve lock cover 40 and is affixed into place therein using screws, spot welds or other methods commonly used in the industry. The valve lock cap 70 would then fit over the valve lock cover 40 in the same manner as in the preferred embodiment and secure the valve in the same manner. One of the significant advantages of the independence between the cover 40 and cap 70 sub-components is the ability to adapt the valve lock 10 to a wide variety of uses.

Referring next to FIG. 3, the valve lock cap 70 has two main components: the cap casing 80 housing a plug cylinder lock 90. Like the filler valve cover 40, the cap casing 80 is hollow, cylindrical, has a cap casing top surface 82, an interior sidewall 83, an exterior sidewall 84, and an open bottom. The interior diameter of the cap casing 80 is slightly larger than the exterior diameter of the valve lock cover 40 so that the cap casing 80 both snugly fits over the cover 40 and also freely rotates around the cover 40 after installation. The casing top surface 82 has an aperture 86 to accept a portion of the plug cylinder lock 90. The exterior sidewall length 84 is slightly longer than the length of the filler valve cover sidewall 44 so that when installed, the valve lock cap 70 completely covers the filler valve cover 40. Unlike the filler valve cover sidewall 44, in the preferred embodiment, the exterior sidewall 84 surface is smooth.

The plug cylinder lock 90 is housed within the cap casing 80. It is essentially cylindrical and includes a protective top 94 that fits over the plug cylinder lock encasement 100. In the preferred embodiment, the cap casing top surface 82 and the plug cylinder lock 90 are affixed perpendicular to each other. The plug cylinder lock encasement 100 includes a protective top 94 is cylindrical and has a top surface at its proximal end, an exterior threaded sidewall shaft 98 and an open distal end. The proximal end has a key opening protective housing 96 surrounding a key opening 92. The key opening protective housing 96 is conicular and hollow, having an open top that is filled by the top surface of the plug cylinder lock encasement protective top 94 and a sloping sidewall that meets the cap casing top 82 at an angle.

The encasement 100 is also cylindrical, has a proximal end, and a distal end. Its proximal end houses a locking mechanism (not shown) and fits into the open, distal end of the protective top 94. The locking mechanism includes a seven (7) pin anti-pick tubular mechanism and has over 60,000 useable key combinations. For more universal use with other styles of plug cylinder locks, the locking mechanism can be keyed alike to other lock styles. The locking mechanism is capable of accepting thousands of different key codes to deflect the possibility of designing a master key to pick the lock. An extendable latch 104 is located within the encasement 100 towards its distal end. The latch 104 is extendable latitudinally radially away from the encasement 100 and past the second edge of the lock cover interior lip 56 when the cap 70 is installed and the latch 104 is extended. The latch 104 retracts completely into the encasement 100. A nut 110 tightens the plug lock 90 tightly onto the cap cover 70.

Referring now to the combined drawings, a valve cover locking device 10 prevents unauthorized access to a propane tank valve 5. The valve cover locking device 10 includes a tank valve cover 40 and a valve lock cap 70. The tank valve cover 40 affixes onto the propane tank valve 5 by first aligning the propane tank filler valve exterior surface threads 8 with the tank valve cover interior surface threads 58 and screwing the tank valve cover 40 onto the propane tank valve 5. The valve cover 40 can initially tightened by hand and then tightened securely into place by a wrench or other tool via the valve cover faceted sides 44. After the valve cover 40 securely attached, the valve lock cap 70 is installed.

Next, the valve lock cap 70 is assembled by inserting the plug cylinder lock 90 through the lock cap casing aperture 86 until the key opening protective housing 96 rests against the top surface of the cap casing top 42. The casing nut 110 is then screwed onto the lock top shaft 98 until the casing nut 110 is tightly against the interior surface of the cap casing top 42 and (in the preferred embodiment) the plug cylinder lock 90 and the lock cap casing 80 are affixed perpendicular to each other.

Then, after the valve lock cap 70 is assembled, it is installed by sliding the distal end of the lock encasement 100 into the valve lock cover's center opening 48 until the valve lock cap 70 slides onto and rests upon the valve cover 40. If the valve lock cap 40 and the valve lock cap 70 are properly seated, the top surface of each will be parallel to each other and the valve lock cap 70 will completely enclose the valve lock cover 40. Additionally, the plug lock latch 104 will rest in the interior of the lock cover 40, distally beyond the lock cover lip 56. With the filler valve locking device 10 seated, the latch 104 may be extended to lock the propane locking device 10 into place. The propane locking device 10 may be unlocked by retracting the latch 104. The latch 104 is extended or retracted using the key 120.

When installed and locked, the propane locking device 10 easily and efficiently secures the filler valve 5. The device 10 cannot be pulled off, because axial longitudinal movement of the device 10 is prevented by the interaction between the plug lock latch 104 and the valve cover lip 56. Additionally, the device 10 is designed so that it cannot be twisted off. The unimpeded interface between the extended latch 104 and the cover lip surface 57 allows the extended latch 104 to freely rotate adjacent and parallel to the lock cover lip surface 57. Because the interior diameter of the valve lock cap 70 is slightly larger than the exterior diameter of the valve lock cover 40, it also rotates freely around the cover 40. Therefore, twisting moment cannot be applied to the cover 40 to break it off. Further, the design of the device 10 prevents it from being pried off by separating the housing 40 from the cap 70. Because the difference between the interior diameter of the valve lock cap 70 and the exterior diameter of the valve lock cover 40 is relatively small, any tool that could be inserted between the valve lock cover 40 and cap 70 would not be strong enough to pry the two apart. Instead, the tool would either bend or break. Further, an attack on the plug lock 90 is deterred by the sloping sidewall of the plug lock protective housing 96. Because the protective housing sidewall is at an angle to the surface of the cap top 82, it is difficult to place a tool at the intersection of the two to try to separate them. Finally, the interaction between the filler valve 5 and the sidewalls 44 and 85 of the valve cover 40 and the lock cap 70, respectively, prevent the latitudinal movement of the valve cover locking device 10. In summary, when locked into place, the filler valve locking device 10 incorporates several design elements that work together to prevent the device from being removed by being pulled, unscrewed, pried, twisted or drilled. These several design elements are not anticipated by prior art.

The current invention offers several advantages over the relatively little prior art in the field. It is much smaller than prior art and therefore easier to use. It is easier to transport. It is also much easier to assemble. Its design is much less complex than prior art, therefore allowing less opportunity for mechanical failure. Its operational concepts are familiar to those who understand the technology in this field of art. Each of these advantages combines to form an invention that is both novel and non-obvious.

While the foregoing detailed description has described several embodiments of a device in accordance with the present invention, the description is illustrative only and not limiting of the disclosed invention. Indeed, it will be appreciated that the embodiments discussed above and other embodiments that are not mentioned could easily be within the scope and spirit of the present invention. Thus, the present invention is limited only by the claims set forth below.

TABLE OF ELEMENTS: PROPANE TANK LOCK - fill valve
Attorney Docket: 001-010-LAIP006

| FIG. | DESCRIPTION |
|---|---|
| 1 | Simplified view of the valve cap and cover of the invention |
| | as they are affixed to a propane tank filler valve |
| 2 | Simplified cross-sectional view of the valve lock cover |
| 3 | Simplified cross-sectional view of the valve lock cap |

NUMBER

| | Major | Sub- | |
|---|---|---|---|
| FIG. | component | component | DESCRIPTION |
| 1 | 5 | | Propane tank filler valve |
| 1 | 10 | | Propane tank locking device |
| 1, 2 | 40 | | Lock Cover Sub-Component |
| 2 | | 42 | Top |
| 2 | | 44 | Exterior sidewall |
| 2 | | 46 | Interior sidewall |
| 2 | | 48 | Center opening |
| 2 | | 50 | Proximal end of opening |
| 2 | | 54 | Distal end of opening |
| 2 | | 56 | Lip at distal end of opening |
| 2 | | 57 | Lip surface at distal end of |
| | | | opening |
| 2 | | 58 | Threaded interior sidewall |
| 1, 3 | 70 | | Lock Cap Sub-Component |
| 3 | 80 | | Lock Cap Casing |
| 3 | | 82 | Lock cap top |
| 3 | | 84 | Interior sidewall |
| 3 | | 84 | Exterior sidewall |
| 3 | | 86 | Aperture |
| 3 | | 88 | |
| 3 | 90 | | Plug Cylinder Lock |
| 3 | | 92 | Key opening |
| 3 | | 94 | Lock top |
| 3 | | 96 | Protective housing |
| 3 | | 98 | Threaded shaft |
| 3 | | 100 | Plug cylinder lock stem/ |
| | | | encasement |
| 3 | | 102 | |
| 3 | | 104 | Latch |
| 3 | | 110 | Casing nut |
| 1, 3 | 120 | | Key |

What is claimed is:

1. A valve lock, comprising a valve lock valve cover and a valve lock locking cap, wherein
said valve lock valve cover is partially enclosed, has an open bottom, a top surface, a sidewall having an exterior surface and a threaded interior surface, and
said valve cover top surface has an outside circumference defining an outer perimeter of the top surface and an inside circumference defining both a valve cover aperture within the top surface and an edge to the cover aperture, the cover aperture edge of the top surface defining a lip within the top surface; and
said valve lock locking cap comprised of a casing and a lock, wherein
the locking cap casing is partially enclosed, has an open bottom, a top surface, an exterior surface and an interior surface, and
the casing's top surface has an outside circumference defining a top surface outer edge and an inside circumference defining both a casing aperture within the casing's top surface and an edge to the casing aperture, and
the locking cap lock has an encasement and a protective top,
the protective top has an opening to receive a key, a protective housing surrounding the key opening and a threaded shaft threaded on its exterior surface, and
the encasement has a locking mechanism and a latch that is both extendable beyond the latch and retractable into the latch, and
whereby said locking cap casing and lock are joined by inserting said lock encasement through the casing aperture until the locking cap lock protective top prevents further ingress, and then threading a nut onto the exterior surface threaded shaft of the protective top until the nut cannot be threaded further; and
whereby said lock is affixed onto a threaded valve by aligning the threaded interior surface of the valve cover sidewall and a valve having a threaded exterior surface, and then screwing the valve cover onto the valve threaded exterior surface and tightening the valve cover into place over the valve; and then
placing the locking cap onto the valve lock valve cover, open end first, by
inserting the lock encasement through the cover aperture until the plug lock latch is beyond the lip of the valve lock valve cover and the cap rests on the cover, and then placing the locking mechanism in a locked position to extend the latch outward from the encasement radially beyond the radius of the valve cover aperture within the valve cover top surface, an edge to the valve cover top surface aperture, and the valve cover top surface aperture lip,
thereby preventing both latitudinal and longitudinal movement of the valve lock after it is placed onto said threaded valve.

2. The invention of claim 1 wherein the valve lock valve cover sidewall exterior surface is faceted.

3. The invention of claim 1 wherein the valve lock valve cover top surface aperture opening is centrally located on the top surface and the aperture further comprises a sidewall that extends from the cover's exterior surface to its interior surface.

4. The invention of claim 1 wherein the valve cover is made from solid brass.

5. The invention of claim 1 wherein the valve lock valve cover and a valve lock locking cap are roughly cylindrical in shape and wherein
the outer circumference of the valve lock valve cover is larger than the inner circumference of the valve lock locking cap such that the valve lock locking cap cover the valve lock locking cap and freely rotate around the valve lock valve cover while paced over it, and whereby
the difference between the outer circumference of the valve lock valve cover and the inner circumference of the valve lock locking cap is too small to allow the insertion of a tool between the valve lock valve cover and the valve lock locking cap to pry the two apart when the valve lock is seated on a valve.

6. The invention of claim 1 wherein said valve lock locking cap automatically extends to a locked position after being inserted into said valve lock cover.

7. A lock, comprising a lock cover and a locking cap, wherein
said lock cover is partially enclosed, has an open bottom, a top surface, a sidewall having an exterior surface and a interior surface, and
said lock cover top surface has an outside circumference defining an outer perimeter of the top surface and an inside circumference defining both a lock cover aperture within the top surface and an edge to the cover aperture, the cover aperture edge of the top surface defining a lip within the top surface; and
said locking cap comprised of a casing and a lock, wherein
the locking cap casing is partially enclosed, has an open bottom, a top surface, an exterior surface and an interior surface, and
the casing's top surface has an outside circumference defining a top surface outer edge and an inside circumference defining both a casing aperture within the casing's top surface and an edge to the casing aperture, and
the locking cap lock has an encasement and a protective top,
the protective top has an opening to receive a key, a protective housing surrounding the key opening and a threaded shaft threaded on its exterior surface, and
the encasement has a locking mechanism and a latch that is both extendable beyond the latch and retractable into the latch, and
whereby said locking cap casing and lock are joined by inserting said lock encasement through the casing aperture until the locking cap lock protective top prevents further ingress, and then threading a nut onto the exterior surface threaded shaft of the protective top until the nut cannot be threaded further; and
whereby said lock is affixed onto a valve or other such lockable protrusion by aligning the valve cover and the valve, and then connecting the valve cover onto the valve; and then
placing the locking cap onto the valve lock valve cover, open end first, by
inserting the lock encasement through the cover aperture until the plug lock latch is beyond the lip of the valve lock valve cover and the cap rests on the cover, and then
placing the locking mechanism in a locked position to extend the latch outward from the encasement radially beyond the radius of the valve cover aperture within the valve cover top surface, an edge to the valve cover top surface aperture, and the valve cover top surface aperture lip,
thereby preventing both latitudinal and longitudinal movement of the valve lock after it is placed onto said valve.

8. The invention of claim 7 wherein the valve lock valve cover sidewall exterior surface is faceted.

9. The invention of claim 7 wherein the valve lock valve cover top surface aperture opening is centrally located on the top surface and the aperture further comprises a sidewall that extends from the cover's exterior surface to its interior surface.

10. The invention of claim 7 wherein the valve cover is made from solid brass.

11. The invention of claim 7 wherein the valve lock valve cover and a valve lock locking cap are roughly cylindrical in shape and wherein
the outer circumference of the valve lock valve cover is larger than the inner circumference of the valve lock locking cap such that the valve lock locking cap cover the valve lock locking cap and freely rotate around the valve lock valve cover while paced over it, and whereby
the difference between the outer circumference of the valve lock valve cover and the inner circumference of the valve lock locking cap is too small to allow the insertion of a tool between the valve lock valve cover and the valve lock locking cap to pry the two apart when the valve lock is seated on a valve.

12. The invention of claim 7 wherein said valve lock locking cap automatically extends to a locked position after being inserted into said valve lock cover.
